(19) United States
(12) Patent Application Publication
(10) Pub. No.: US 2008/0164355 A1
(43) Pub. Date: Jul. 10, 2008

(54) Noise reduction motor and components for shredder

(76) Inventor: Tie Chun Wang, Taipei (TW)

Correspondence Address: SEDGWICK, DETERT, MORAN & ARNOLD, LLP (LA), 801 SOUTH FIGUEROA ST., 18TH FLOOR, LOS ANGELES, CA, 90017, US

(21) Appl. No.: 11/650,266

(22) Filed: Jan. 5, 2007

(51) Int. Cl. B02C 4/00

(52) U.S. Cl. 241/277

(57) ABSTRACT

The present invention relates generally to shredder noise reduction. Specifically, this invention discloses shredder motor gears and belts which are coated with a dampening material to reduce noise. Additionally, the invention discloses the placement of vibration absorbers between the motor assembly and the shredder housing, as well as the rotary cutting assembly and shredder housing, thus further facilitating noise reduction.

### BACKGROUND OF THE INVENTION

1. Field of the Invention

The present invention relates generally to shredder motors and the coupling of the motor housing to the shredder housing. Specifically, this invention discloses shredder motor gears and belts which are coated to reduce noise. Additionally, the invention discloses the placement of vibration absorbers between the motor assembly and the shredder housing, as well as between the rotary cutting assembly and shredder housing, thus further facilitating noise reduction.

2. Background Information

With increased privacy concerns, shredders have become an integral part in both homes and businesses. Though originally used to destroy paper products, shredders are now used to shred other forms of media that hold information, such as compact discs. In addition, credit cards and other plastic products are commonly shredded.

Shredders create a substantial amount of noise because the shredding mechanism is comprised of a motor driven by gears that are made of steel. Since the gears are made of steel, the teeth of the gears cause vibration and noise when they interlock. In addition, both the motor assembly and rotary cutting assembly are directly coupled to the shredder housing leading to a direct transfer of the noise and vibration to the shredder housing.

The present invention employs a coating such as rubber around the gears to reduce noise and vibration. In addition, rather than have the gears directly interlock with other gears, a belt may be used to connect the gears. The belt may also be coated with rubber, or a like substance to provide further noise reduction. Finally, vibration absorbers may be used to couple the motor assembly and rotary cutting assembly to the shredder housing.

From the preceding descriptions, it is apparent that the devices currently being used have significant disadvantages and/or limitations. Thus, important aspects of the technology used in the field of invention remain amenable to useful refinement.

### SUMMARY OF THE INVENTION

The present invention relates to an apparatus that satisfies the need for a shredder with decreased noise output. In one preferred embodiment, gears typically made of steel are coated with rubber or a like substance. Rather than have the noise and vibration from steel to steel contact reverberate throughout the shredder, the rubber coated gears dampen both the noise and vibration. In addition, rather than have gears directly interlock, a belt coated with rubber, or a like substance, can lead to further noise and vibration dampening. Finally, vibration absorbers may be used to couple the motor assembly and rotary cutting assembly to the shredder housing thus further reducing the vibration and noise emanating from the motor.

All of the foregoing operational principles and advantages of the present invention will be more fully appreciated upon consideration of the following detailed description with reference to the drawings.

### BRIEF DESCRIPTION OF THE DRAWINGS

The features and advantages of this invention are better understood with regard to the following drawings, description, and claims. The drawings consist of the following:

FIG. 1 is a top plan view of a shredder housing and shredder mechanism embodying features of the prior art.

FIG. 2 is a cross sectional side view of a shredder housing and shredder mechanism embodying features of the prior art.

FIG. 3 is a side view of a gear embodying features of this invention.

FIG. 4 is an exploded side view of the teeth of a gear embodying features of this invention.

FIG. 5 is a side view of a belt and gears embodying features of this invention.

FIG. 6 is a top plan view of a shredder housing and shredder mechanism embodying features of this invention.

FIG. 7 is a cross sectional side view of a shredder housing and shredder mechanism embodying features of this invention.

### DETAILED DESCRIPTION OF THE INVENTION

The essential elements of a shredder are comprised of a base (not shown), a housing 1, and a shredder mechanism 2 which resides in the housing. The housing 1 is comprised of a throat 2 through which materials to be shredded are fed. The materials are shredded in a shredder mechanism 3 which is comprised of a rotary cutting assembly 4 and a motor assembly 5.

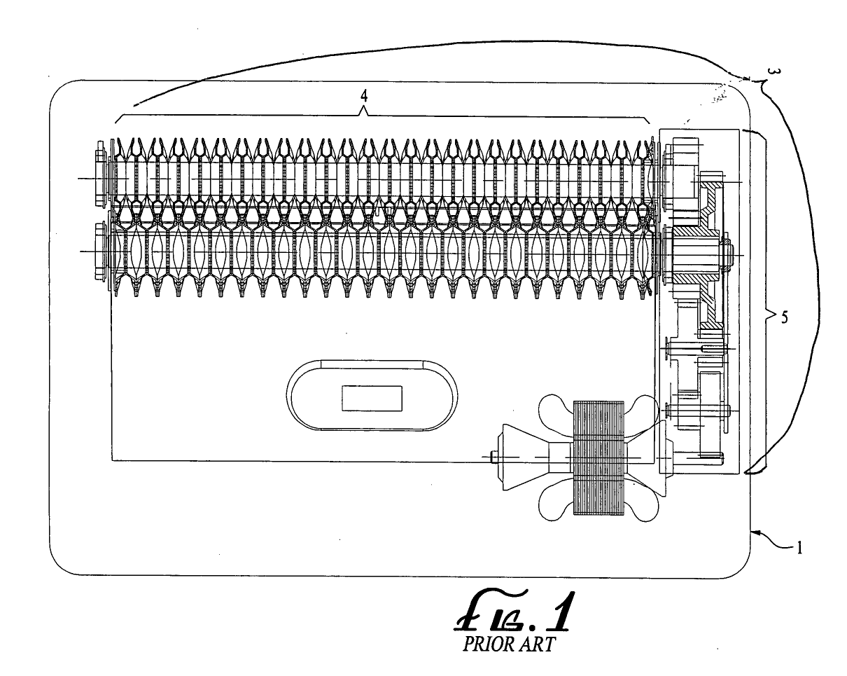

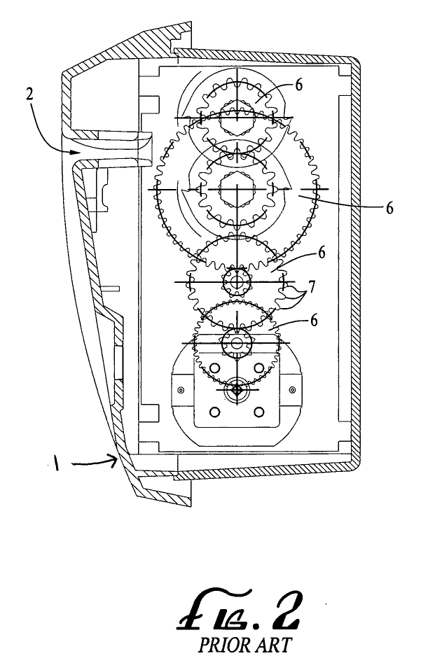

Typically the gears 6 of the motor assembly 4 are made of a hardened metal such as steel. As seen in the prior art in FIGS. 1 and 2, the gears 6 have teeth 7 which align and transfer rotary power to the rotary cutting assembly 4. In addition the motor assembly 5 is coupled directly to the shredder housing 1.

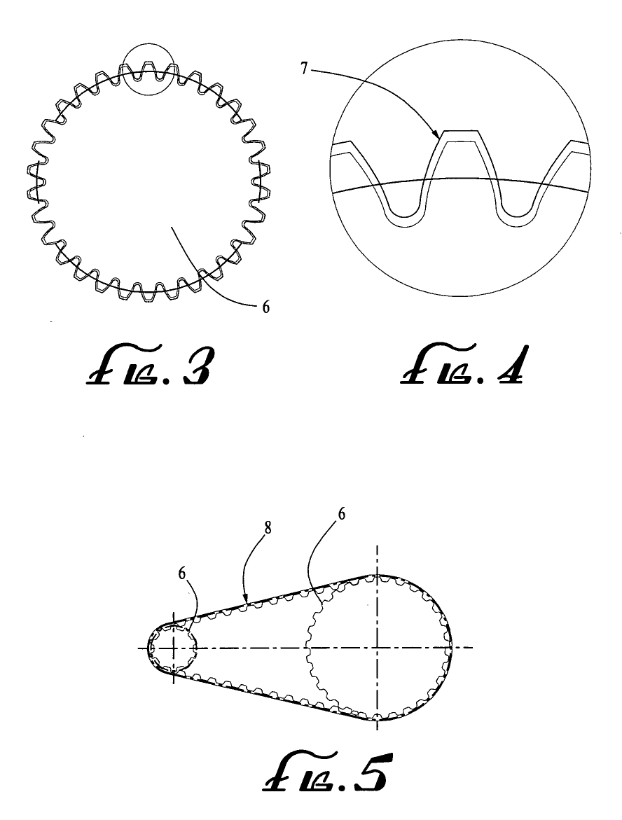

In this preferred embodiment the motor assembly 5 is comprised of at least one coated gear. FIGS. 3 and 4 disclose a coated gear 6. The gear is preferably coated by with silicon rubber or polyurethane and Teflon. The coating provides a noise and vibration dampening effect when the teeth of the gear are in contact with another gear or belt.

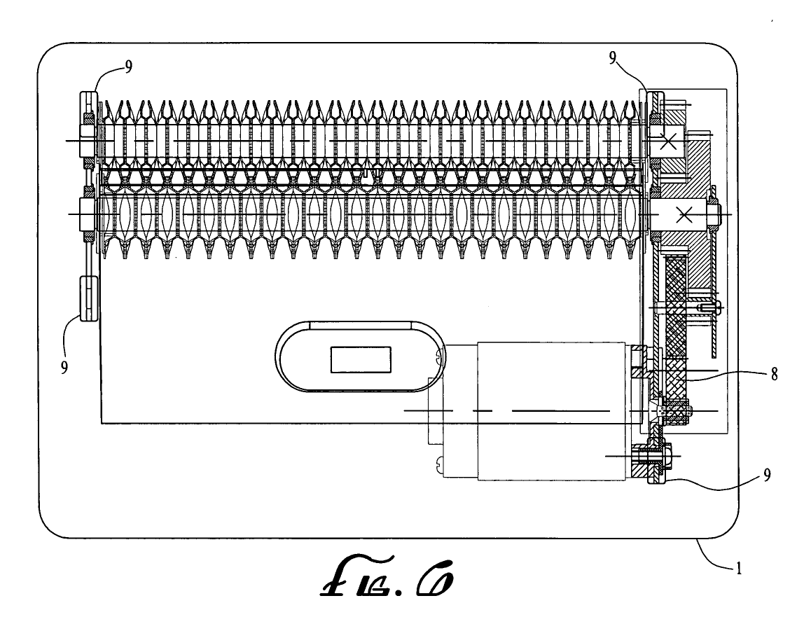

To further reduce noise, rather than have gears contact each other directly in the motor assembly, a belt can be used to connect the gears. FIG. 5 shows a coated belt 8 connecting two coated gears. The belt is preferably coated with rubber or silicon rubber.

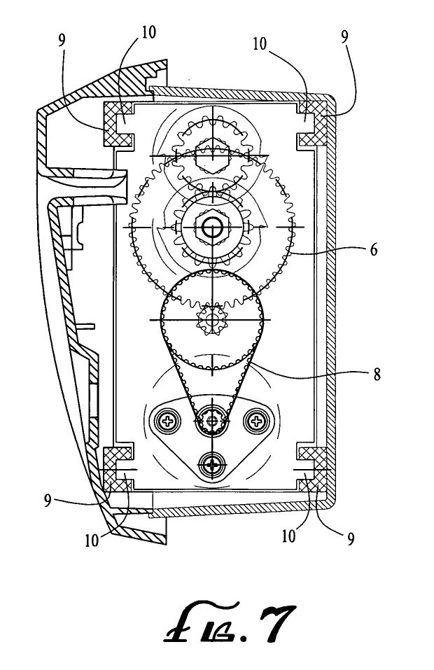

Finally, as demonstrated in FIGS. 6 and 7 vibration absorbers 9 may be used to couple the motor assembly 5 and/or the rotary cutting assembly 4 to the housing 1. The vibration absorbers 9 are preferably made of rubber or silicon rubber molded in a U-shape. The vibration absorbers 9 can then be readily fastened to a projection 10 from the motor assembly 5 or rotary cutting assembly 4. The use of vibration absorbers to couple the motor assembly to the housing further reduces noise by absorbing the noise and vibration that is typically relayed from the coupling of the motor assembly to the housing or the rotary cutting assembly to the housing.

Although the present invention has been described in detail with respect to certain preferred versions thereof, other versions are possible. Therefore, the scope of the claims should not be limited to the description of the preferred versions contained herein.

1. A shredder comprised of:
(a) a base and
(b) a housing;
wherein said housing contains a throat through which materials to be shredded are inserted and a shredder mechanism;
wherein said shredder mechanism is comprised of a rotary cutting assembly and a motor assembly
wherein said motor assembly is comprised of at least one coated gear.

2. The shredder of claim 1 wherein said coated gear is coated with silicon rubber.

3. The shredder of claim 1 wherein said coated gear is coated with polyurethane and Teflon

4. A shredder comprised of:
(a) a base and
(b) a housing;
wherein said housing contains a throat through which materials to be shredded are inserted and a shredder mechanism;
wherein said shredder mechanism is comprised of a rotary cutting assembly and a motor assembly
wherein said motor assembly is comprised of at least one coated belt.

5. The shredder of claim 4 wherein said coated belt is coated with rubber.

6. The shredder of claim 4 wherein said coated belt is coated with silicon rubber.

7. A shredder comprised of:
(a) a base and
(b) a housing;
wherein said housing contains a throat through which materials to be shredded are inserted and a shredder mechanism;
wherein said shredder mechanism is comprised of a rotary cutting assembly and a motor assembly
wherein said motor assembly is comprised of at least one coated belt and at least one coated gear.

8. The shredder of claim 7 wherein said rotary cutting assembly is coupled to the shredder housing with at least one vibration absorber.

9. The shredder of claim 7 wherein said motor assembly is coupled to the shredder housing with at least one vibration absorber.

10. The shredder of claim 8 or 9 wherein said vibration absorber is made with rubber or silicone rubber.

11. The shredder of claim 10 wherein said vibration absorber is U-shaped and couples to an appendage of the housing.
